(19) United States
(12) Patent Application Publication
(10) Pub. No.: US 2015/0281292 A1
(43) Pub. Date: Oct. 1, 2015

(54) Data File Discovery, Visualization, and Actioning

(71) Applicant: PlusAmp, Inc., Tokyo (JP)

(72) Inventors: Toshihiro Murayama, Tokyo (JP); William Harris Yeskel, Tokyo (JP); Jonathan Stuart Epstein, Tokyo (JP); Yoon Sung Kim, Austin, TX (US)

(21) Appl. No.: 14/514,273

(22) Filed: Oct. 14, 2014

Related U.S. Application Data
(63) Continuation-in-part of application No. 14/494,378, filed on Sep. 23, 2014.
Application No. 14/494,378 is a continuation of application No. 14/225,139, filed on Mar. 25, 2014, now Pat. No. 8,862,646.

(51) Int. Cl. H04L 29/06; G06F 3/0484; G06F 3/0481; G06F 17/30

(52) U.S. Cl. CPC H04L 65/403; G06F 17/30011; G06F 17/30864; G06F 3/0484; G06F 3/0481

(57) ABSTRACT

Various data source locations storing files can be accessed and/or crawled. At each location, files can be identified. These files can be analyzed to obtain attributes characterizing such file. Thereafter, a visualization can be generated in a graphical user interface that takes the form of data map that characterizes the identified files along two or more dimensions, with each dimension being based on a different attribute of the file. For example, the vertical dimension can be based on a number of columns and the horizontal dimension can be based on a number of rows. The graphical user interface can include graphical user interface elements associated with each identified file. These elements, when activated, can cause one or more actions to be initiated.

### CROSS REFERENCE TO RELATED APPLICATIONS

The current application claims priority to U.S. patent application Ser. No. 14/494,378 filed on Sep. 23, 2014 which, in turn, is a continuation of U.S. patent application Ser. No. 14/225,139 filed on Mar. 25, 2014 (and issued as U.S. Pat. No. 8,862,646), the contents of both of which are hereby fully incorporated by reference.

### TECHNICAL FIELD

The subject matter described herein relates to discovery of data files across various storage locations and types and visualizations characterizing same. The current subject matter also provides enhanced techniques for taking action upon such visualized files such as displaying more detailed information, stitching, sharing, and importing the visualized files.

### BACKGROUND

Entities ranging from individuals to large multi-national entities are generating increasing amounts of data files including files encapsulating tabular data as well as growing use of application produced data from the web. These files can be stored among various disparate locations including local storage, networked storage, email/email attachments, and in cloud-based storage services. Navigating and accessing such files becomes more burdensome as the number of files and their storage locations increase.

### SUMMARY

In a first aspect, data source locations are accessed or crawled to identify files comprising data. Thereafter, each identified file is analyzed to obtain attributes characterizing the file. A data map is then generated that characterizes the identified files along at least two dimensions. A first dimension is based on a first attribute of the corresponding identified file. A second dimension is based on a second attribute of the corresponding identified file. In addition, at least one identified file has a corresponding graphical user interface element.

The data map can take various forms including a scatter plot and a tabular form.

In addition, user-generated input can be received that activates activating at least one of the graphical user interface elements with at least one associated identified file. In response, at least one action can be initiated using the at least one associated identified file.

The action can include displaying further data characterizing the at least one associated identified file.

The action can include initiating importation of the at least one associated identified file into an application. Uses within the application can range from data exploration using sorting and grouping to drawing charts. Other uses can include analytics involving mathematical functions, statistics, or other quantitative methods. Or the application may use the files as inputs into a bigger/higher level process.

The action can include sharing of the at least one corresponding identified file. The sharing can include generating a unique hashtag or uniform resource locator (URL), which when activated, causes the corresponding at least one identified file to be accessed. The sharing can include specifying access restrictions on the corresponding at least one identified file. The sharing can encapsulate any filtering criteria used in connection with discovery of the at least one corresponding identified file.

A size and/or color of each graphical user interface element can be based on a further attribute of the corresponding identified file that is different from the first attribute and the second attribute.

A shape of each graphical user interface element can be based on a further attribute of the corresponding identified file that is different from the first attribute and the second attribute.

The data map can characterize the identified files along at least one other dimension with each dimension being based on a different attribute of the corresponding identified file.

The data within each identified file can, in some cases, include tabular data.

The data source locations are selected from a group consisting of: local data stores, network accessible data stores, e-mail servers, cloud-based data storage services.

The attributes can include one or more: identified file location, column names, row names, a number of rows, a number of columns, file size, file creation date, application that generated the identified file, file modification date, file access dates, number of times the file has been accessed, file type, author of the file, individuals who have accessed the file, access control list data, authorization level of entities who can or who have accessed the file, department of entities who can or who have accessed the file, exclusion lists, data ranges, data formats, table structure, file structure, mathematical sequences within the file, keywords contained within the file, and summaries of some or all of the contents of the file.

The data can include data to render at least one pivot table.

In some variations, at least one identified file is parsed into two or more components. In such cases, the attributes are obtained for each component and each component can have a different corresponding graphical user interface element within the data map. Each component can be a separate set of tabular data.

The identified files can have different types including, but not limited to: .acv, .adp, .ai, .aif, .aiff, .air, .amp, .aod, .aps, .asc, .asf, .aspx, .att, .atf, .atx, .au, .avi, .aux, .bak, .bas, .bck, .bin, .bd, .bkf, .bmc, .bmp, .bud, .cbl, .cc, .cd, .cct, .cda, .cdd, .cdr, .cdt, .cdx, .cfm, .cfml, .clp, .cpp, .cs, .csproj, .cst, .csv .ctl, .ctx, .cur, .cwf, .cxx, .dat, .db, .dbc, .dbf, .dbquery, .dbx, .dir, .doc, .docx, .dot, .dotm, .dotx, .drw, .dwf, .dwfx, .dwg, .dwt, .dxb, .dxf, .dxr, .eml, .eps, .eps2, .exe, .fla, .flk, .fly, .fm, .fp5, .fp7, .frm, .gvp, .gz, .gzip, .hlp, .ht, .htc, .htm, .html, hta, .iif, .img, .ind, .isd, .ism, .iso, .iss, .iwp, .jad, .jar, .java, .jfif, .jgw, .jhtm, .jhtml, .jnl, .job, .jpg, .jpeg, .js, .lab, .ldf, .ldif, .lgo, .lha, .lit, ink, .lock, .logl, .log2, .lzh, .mlv, .m2ts, .m3u, .moa, .mor, .map, .maq, .mar, .marc, .mat, .mco, .md5, .mdb, .mde, .mdf, .mdi, .mdmp, .mht, .mid, .mif, .mim, .mix, .mmap, .mod, .modd, .moff, .mot, .mov, .movie, .moz, .mp2, .mp3, .mp4, .mpe, .mpeg, .mpg, .mpt, .msg, .msdvd, .msg, .msi, .msm, .msp, .mst, .msv, .myd, .myi, .nch, .ncb, .nk2, .nn, .nrg, .nws, .o, .obj, .oca, .ocx, .odc, .oft, .ops, .opt, .pab, .pal, .par, .par2, .part, .pbm, .pce, pdd, .pde, .pdf, .pic, .pict, .pid, .pif, .pip, .pjp, .jpjeg, .pmd, .png, .pot, .ppm, .ppt, .prf, .prn, .ps, .psd, .psp, .pst, .pub, .qif, .qt, .r00, .r01, .r02, .r03, .r04, .r05, .ra, .ram, .rar, .raw, .rc, .rdi, .reg, .rm, .rpc, .rtf, .rtx, .sas, .sas7dbat, .sas7bvew, .sav, .sbl, .sbx, .scf, .scr, .sea, .sfx, .sh, .smi, .snd, .snp, .spo, .sps, .sql, .sqlite, .sqm, .stc, .std, .sti, .stm, .sv7, .sxc, .sxg, .sxm, .sxp, .sxw, .syd, .syo, .sys, .tab. .tar, .tif, .tiff, .tib, .tmb, .tmd, .tsv, .txt, .vb, .vbproj, .vbs, .vbx, .vcf, .vhd, .vm, .vsd, .vsi, .vsix, .vspscc, .vsscc, .vssscc, .wab, .wav, .wave, .wdb, .wer, .whb, .win, .wk1, .wk2, .wk3, .wk4, .wks, .wma, .wmv, .wms, .wmz, .wor, .wp, .wp2, .wp3, .wp4, .wpd, .wpp, .wps, .wpt, .prf, .wrj, .wrl, .wrz, .wtv. .wvf, .wvx, .xhtml, .xla, .xlam, .xlb, .xlc, .xld, .xlk, .xll, .xlm, .xlr, .xls, .xlsb, .xlsm, .xlsx, .xlt, .xltm, .xlv, .xlw, .xml, .xps, .xrp, .xsd, .xslt, .xspf, .xtf, .xxx, zip, .zipx, and .zix format files.

Two or more of the identified files can be stitched together to form a single file. The stitching can include identifying common attributes among the identified files, and combining the files using at least one of the common attributes. The identifying common attributes can be based on user-generated input that specifies the common attributes. The common attributes can include: identified file location, column names, row names, a number of rows, a number of columns, file size, file creation date, application that generated the identified file, file modification date, file access dates, number of times the file has been accessed, file type, author of the file, individuals who have accessed the file, access control list data, authorization level of entities who can or who have accessed the file, department of entities who can or who have accessed the file, exclusion lists, data ranges, data formats, table structure, file structure, mathematical sequences within the file, keywords contained within the file, and summaries of some or all of the contents of the file. The common attributes can be identified using at least one stitching suggestion methodology.

A keyword cloud can be displayed in the graphical user interface that identifies common attributes among the identified files. The user-generated input can include selecting at least one graphical user interface element associated with the specified common attributes.

The identifying of common attributes can also include polling or accessing an attributes index to identify the files having the common attributes.

The data source locations can include compressed files and such files can be decompressed using various methodologies. Similarly, the data source locations can include encrypted files and such files can be decrypted using various methodologies.

User-generated input can be received that activates at least one of the graphical user interface elements with at least one corresponding identified file. In response, a new analysis of files from the data source locations can be opened using the at least one corresponding identified file. Alternatively, an existing analysis of files can be accessed and the at least one corresponding identified file can be added to such existing analysis.

In some cases, the attributes for the files can be indexed or otherwise made available from previous crawling/access of such files. In such variations, an index is accessed that specifies attributes for each of a plurality of files stored at a plurality of data source locations. Thereafter, a data map is generated in a graphical user interface that characterizes the files along at least two dimensions. A first dimension is based on a first attribute of the corresponding file. S second dimension is based on a second attribute of the corresponding file. At least one file has a corresponding graphical user interface element. User-generated input can be received that activates at least one of the graphical user interface elements with at least one associated file. An action is then initiated using the at least one associated file.

In another aspect, a graphical user interface displays available categories of files at a first level. Thereafter, user-generated input is received selecting one of the categories at the first level. The available categories of files at a second level are then displayed in the graphical user interface. Further, user-generated input is received that selects one of the categories at the second level. Available categories of files are then displayed at the third level. The graphical user interface renders each category so that it has a size relative to a number of corresponding files within such category. As on example, the first level is data source types, the second level is data file content types, and the third level is data file format types.

In a further aspect, various data source locations storing files can be accessed and/or crawled. At each location, files taking various forms and/or their contents (e.g., tabular data) can be identified. Thereafter, a visualization can be generated in a graphical user interface that takes the form of data map that characterizes the identified files and/or tables along two or more dimensions, with each dimension being based on a different attribute of the file. For example, in the case of tabular data, the vertical dimension can be based on a number of columns and the horizontal dimension can be based on a number of rows. The size/shape/colors of elements can represent other dimensions. In tabular views of the results the attributed can be represented as columns or within the rows. Or in alternative visualizations as stacked bars. The graphical user interface can include graphical user interface elements associated with each identified file and/or table. These elements, when activated, can cause complementary information characterizing the corresponding identified file and/or table to be displayed. In addition, the elements can be used to import or otherwise utilize one of the identified files and/or tables into an application (such as statistical software). For example, such application can include a palette or other landing pad on which the corresponding graphical user interface elements can be dragged or otherwise exported from the data map for use by the application or for sharing via email or URL. In a first aspect, various data source locations storing files can be accessed and/or crawled. At each location, files taking various forms and/or their contents (e.g., tabular data) can be identified. Thereafter, a visualization can be generated in a graphical user interface that takes the form of data map that characterizes the identified files and/or tables along two or more dimensions, with each dimension being based on a different attribute of the file. For example, in the case of tabular data, the vertical dimension can be based on a number of columns and the horizontal dimension can be based on a number of rows. The size/shape/colors of elements can represent other dimensions. In tabular views of the results the attributed can be represented as columns or within the rows. Or in alternative visualizations as stacked bars. The graphical user interface can include graphical user interface elements associated with each identified file and/or table. These elements, when activated, can cause complementary information characterizing the corresponding identified file and/or table to be displayed. In addition, the elements can be used to import or otherwise utilize one of the identified files and/or tables into an application (such as statistical software). For example, such application can include a palette or other landing pad on which the corresponding graphical user interface elements can be dragged or otherwise exported from the data map for use by the application or for sharing via email or URL.

In an interrelated aspect, data source locations available to a user are crawled or accessed to identify files comprising data. Thereafter, each identified file is accessed to obtain attributes characterizing the file. A data map is then generated in a graphical user interface that characterizes the identified files along at least two dimensions. A first dimension is based on a first attribute of the corresponding identified file. A second dimension is based on a second attribute of the corresponding identified file, each identified file having a corresponding graphical user interface element. User-generated input is then received that activates one of the graphical user interface elements with a corresponding identified file. In response to the user-generated input, importation of the identified file corresponding to the activated graphical user interface element into an application is initiated.

In yet another interrelated aspect, data source locations that are available to a user are accessed or crawled to identify files comprising tabular data (i.e., one or more discrete tables, etc.). At least one of the files comprises at least two components each having a separate set of tabular data. Thereafter, each set of tabular data is analyzed to obtain attributes characterizing the corresponding set of tabular data. Thereafter, a data map is generated in a graphical user interface that characterizes the sets of tabular data along at least two dimensions. A first dimension is based on a first attribute of the corresponding set of tabular data. A second dimension is based on a second attribute of the corresponding set of tabular data. Each set of tabular data can have a corresponding and different graphical user interface element (for files with multiple components, each set of tabular data would have a different GUI element).

User-generated input selecting one of the elements can result in the corresponding set of tabular data to be imported into an application and/or it can cause complementary information characterizing the tabular data to be displayed.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter provides an enhanced user experience in identifying and characterizing various data files and the use of same in various applications.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating discovery, visualization and importing of tabular data;

FIG. 2 is a first view of a data map visualization;

FIG. 3 is a second view of a data map visualization;

FIG. 4 is a third view of a data map visualization;

FIG. 5 is a fifth view of a data map visualization;

FIG. 6 is a sixth view of a data map visualization;

FIG. 7 is a seventh view of a data map visualization;

FIG. 8 is a view of a tabular format visualization;

FIG. 9 is a first view of a data file discovery interface;

FIG. 10 is a second view of a data file discovery interface;

FIG. 11 is a third view of a data file discovery interface;

FIG. 12 is a fourth view of a data file discovery interface; and

FIG. 13 is a fifth view of a data file discovery interface.

### DETAILED DESCRIPTION

The current subject matter is directed to methods, systems, apparatus, articles/computer program products for one or more of discovering, visualizing, and importing data tables from files among various data sources (having different locations and types within a larger network). While the foregoing sometimes refers to a platform, it will be appreciated that the functionality provided by such platform can embodied in different modalities.

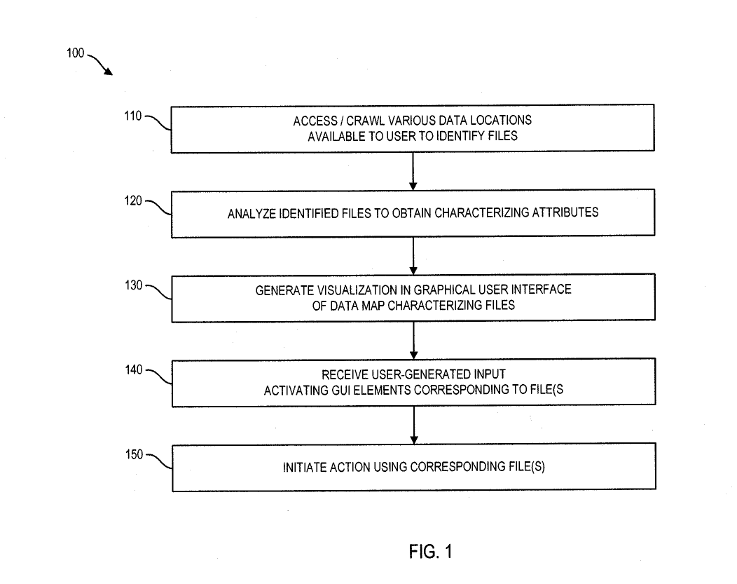

FIG. 1 is a process flow diagram 100 illustrating a method in which, at 110, various data source locations storing files can be accessed and/or crawled. At each location, files (e.g., files comprising tabular data, etc.) can be identified. Thereafter, at 120, the identified files can be analyzed to obtain attributes associated with each file. Subsequently, at 130, a visualization can be generated in a graphical user interface (sometimes referred to herein as a data map) that characterizes the identified files along two or more dimensions, with each dimension being based on a different attribute of the file. For example, if the identified files comprise tabular data, the vertical dimension can be based on a number of columns and the horizontal dimension can be based on a number of rows (and the visualization can characterize the tabular data as opposed to the identified file). The graphical user interface can include graphical user interface elements associated with each identified file that can be selected by a user. These elements, when activated, at 140, can cause an action to be taken with regard to the corresponding at least one selected file.

In other variations, the attributes for the files can be indexed or otherwise made available from previous crawling/access of such files. In such variations, an index is accessed that specifies attributes for each of a plurality of files stored at a plurality of data source locations. Thereafter, a data map is generated in a graphical user interface that characterizes the files along at least two dimensions. A first dimension is based on a first attribute of the corresponding file. S second dimension is based on a second attribute of the corresponding file. At least one file has a corresponding graphical user interface element. User-generated input can be received that activates at least one of the graphical user interface elements with at least one associated file. An action is then initiated using the at least one associated file.

The actioning can take a variety of forms. For example, the action can comprise the display of complementary information (e.g., one or more of the obtained attributes, etc.) characterizing the corresponding at least one selected file. The action can additionally include importation of the at least one selected filed into an application (such as a statistical software application such as a spreadsheet software application). Similarly, the action can comprise the sharing of the at least one selected file (for example, by URL, hashtag, etc.). Still further, the action can comprise combining the at least one selected file with each other (if there are two or more) and/or combining the at least one selected file with another previously selected file or files. For example, such application can include a palette or other landing pad on which the elements can be dragged from the data map to initiate such action.

The platform can initiate a discovery process by crawling through or otherwise accessing files associated with or otherwise available to a user. In some cases, all files associated or otherwise available to the user can be crawled/accessed, while in other cases, certain filters (keyword filtering, user authorization information, other contextual information, etc.) can be applied such that only a subset of such files can be crawled/accessed. The files can be available via different types of data sources and/or different locations. For example, the locations crawled can include local computer drives (relative to the user), network accessible drives, third party web accessible cloud storage services (e.g., DROPBOX, AMAZON, BOX, etc.), e-mail servers (e.g., OUTLOOK.COM, GMAIL, YAHOO, etc.) and the like. In some cases, such as the cloud storage services and e-mail servers, credentials such as username and password can be utilized to authenticate the user at such data locations. Network (e.g., local, wireless, web-based, etc.) connections can be established on case-by-case or recurring basis to subject application produced data to the crawling process. Such connections can, in some cases, handle any required authentication that might be required to access the corresponding data (e.g., username/password, etc.).

The platform can discover a wide variety of file types. It will be appreciated that files can include structured data such as data files and also include unstructured data ranging from text documents to videos or music. Example file types (i.e., file formats) can include .acv, .adp, .ai, .aif, .aiff, .air, .amp, .aod, .aps, .asc, .asf, .aspx, .att, .atf, .atx, .au, .avi, .aux, .bak, .bas, .bck, .bin, .bd, .bkf, .bmc, .bmp, .bud, .cbl, .cc, .cd, .cct, .cda, .cdd, .cdr, .cdt, .cdx, .cfm, .cfml, .clp, .cpp, .cs, .csproj, .cst, .csv, .ctl, .ctx, .cur, .cwf, .cxx, .dat, .db, .dbc, .dbf, .dbquery, .dbx, .dir, .doc, .docx, .dot, .dotm, .dotx, .drw, .dwf, .dwfx, .dwg, .dwt, .dxb, .dxf, .dxr, .eml, .eps, .eps2, .exe, .fla, .flk, .fly, .fm, .fp5, .fp7, .frm, .gvp, .gz, .gzip, .hlp, .ht, .htc, .htm, .html, hta, .iif, .img, .ind, .isd, .ism, .iso, .iss, .iwp, .jad, .jar, .java, .jfif, .jgw, .jhtm, .jhtml, .jnl, .job, .jpg, .jpeg, .js, .lab, .ldf, .ldif, .lgo, .lha, .lit, ink, .lock, .logl, .log2, .lzh, .mlv, .m2ts, .m3u, .m4a, .m4r, .map, .maq, .mar, .marc, .mat, .mco, .md5, .mdb, .mde, .mdf, .mdi, .mdmp, .mht, .mid, .mif, .mim, .mix, .mmap, .mod, .modd, .moff, .mot, .mov, .movie, .moz, .mp2, .mp3, .mp4, .mpe, .mpeg, .mpg, .mpt, .msg, .msdvd, .msg, .msi, .msm, .msp, .mst, .msv, .myd, .myi, .nch, .ncb, .nk2, nn, .nrg, .nws, .o, .obj, .oca, .ocx, .odc, .oft, .ops, .opt, .pab, .pal, .par, .par2, .part, .pbm, .pce, pdd, .pde, .pdf, .pic, .pict, .pid, .pif, .pip, .pjp, .jpjeg, .pmd, .png, .pot, .ppm, .ppt, .prf, .prn, .ps, .psd, .psp, .pst, .pub, .qif, .qt, .r00, .r01, .r02, .r03, .r04, .r05, .ra, .ram, .rar, .raw, .rc, .rdi, .reg, .rm, .rpc, .rtf, .rtx, .sas, .sas7dbat, .sas7bvew, .sav, .sbl, .sbx, .scf, .scr, .sea, .sfx, .sh, .smi, .snd, .snp, .spo, .sps, .sql, .sqlite, .sqm, .stc, .std, .sti, .stm, .sv7, .sxc, .sxg, .sxm, .sxp, .sxw, .syd, .syo, .sys, .tab. .tar, .tif, .tiff, .tib, .tmb, .tmd, .tsv, .txt, .vb, .vbproj, .vbs, .vbx, .vcf, .vhd, .vm, .vsd, .vsi, .vsix, .vspscc, .vsscc, .vssscc, .wab, .wav, .wave, .wdb, .wer, .whb, .win, .wk1, .wk2, .wk3, .wk4, .wks, .wma, .wmv, .wms, .wmz, .wor, .wp, .wp2, .wp3, .wp4,.wpd, .wpp, .wps, .wpt, .prf, .wrj, .wrl, .wrz, .wtv. .wvf, .wvx, .xhtml, .xla, .xlam, .xlb, .xlc, .xld, .xlk, .xll, .xlm, .xlr, .xls, .xlsb, .xlsm, .xlsx, .xlt, .xltm, .xlv, .xlw, .xml, .xps, .xrp, .xsd, .xslt, .xspf, .xtf, .xxx, zip, .zipx, and .zix format files and any other file type that can encapsulate data (such as tables). Compressed files (ZIP, TAR etc.) composed of these or similar files can be unpacked/decompressed, and the constituent files can be included as part of the discovery process.

For each file identified by the platform as part of the discovery process, the platform can obtain attributes characterizing the file. For example, metadata can be identified and cataloged (e.g., at a local or remote data store/indexed, etc.). The metadata can include, for example, file size, file type, location, program that generated the file, creation date, modified data, author, and the like.

The platform can also search and calculate the components of each file to derive other relevant attributes describing the content (which can be considered herein as attributes). For example, these attributes can include a number of times the file has been accessed, name of the organization/department, number of data columns, number of data rows, names of column titles, and statistics derived from the underlying data. In addition, usage statistics can be used such as the most recent time the file was accessed, the name of the individual who last accessed the file, the author of the file, the date that the file was created. Other information can be used including summaries of the contents of files, data ranges, date ranges, data formats, etc. Furthermore summaries of file attributes can be utilized.

The platform can also parse (or otherwise breakdown) each file into its major components (when applicable) and store/catalog each analyzed component separately. For example, an Excel file can comprise multiple sheets and tables, and each such sheet and table is referred to herein as a component. Components deriving from a single file can be analyzed separately. In the case of tabular data, the platform can identify and catalog column/row names and a number of columns/rows. In the case of .wav (or other audio file types) or video files, the platform can identify spoken or sung words, or otherwise characterize the audio portion of such files. In the case of text files, the platform can identify attributes such as numbers of sentences, paragraphs, language(s) used, types of speech, length of the document, and the like.

The attributes collected from each file can be indexed or otherwise collected. Such collection can occur in real-time and/or beforehand. With the latter arrangement, attributes identified from previous file crawling can be indexed and/or otherwise made available for future queries, etc. In some cases, the date of modification for each file can be checked to confirm that the indexed records remain accurate with regard to such file.

The platform can also identify an attribute of the files and present a keyword cloud (selectable elements in a graphical user interface, etc.) for the user to select relevant attribute values for further query. For example, the keyword cloud can include column names of tables and it can present a keyword cloud for the user to select relevant column names for further query. With this example, column names can be indexed to a dictionary of commonly used terms, such that the platform can prioritize similar phrases/cognates in the presentation to the user. For example, the platform can identify that “P&L” and “Profit and Loss” refers to the same concept, as do “GDP” and “Gross Domestic Product.” The dictionary used by the keyword cloud can be multilingual to enable working across languages. For example, by knowing that [symbol] [symbol] (son'eki keisansho) in Japanese refers to the concept of P&L. Such an arrangement is advantageous as the process of identifying specific tables from a large variety of files is simplified and more intuitive from a user perspective. These terms can be used to form a keyword cloud that can be used both for analysis, grouping, and other purposes.

In some cases, a keyword cloud can be presented to a user to enable manual filtering of a result set and the like. The keyword cloud can be used to stitch (e.g., combine, join, merge, concatenate, etc.) individual tables into a single table within a single file. For example, to form a comprehensive table on an economic item such as GDP from all file that have been crawled or otherwise accessed, a user can select keywords from the keyword cloud: GDP, a certain range of dates, and various country or region names. These keywords can be used to identify those tables that are candidates for stitching. One advantage of discovering data in this manner is the ability to locate and stitch many tables together to create a more complete, new table out of disparate tables from disparate locations. This streamlines processes such as finding and joining related data or the process of completing a time series from files that were created or emailed at different points in time and/or may be stored in various locations or on various user email accounts.

Collected attributes can be used for machine generated suggested combines. The platform can auto detect files with similarities and suggests that the user may want to combine in the receiving and initiating stages of the processing. For example, there may be many tables with similar columns as judged by keywords and the dictionary but different time ranges for the rows. The platform would thus suggest a combine to complete the time series. The key idea is that users often needed a discovery process and attributes to find related columns or rows across datasets and locations to combine and use together. Another example is that multiple tables may contain data with similar characteristics, but with distinct header labels. In this case, the platform can suggest a combined table containing the columns of each.

Furthermore, suggested tables to stitch are not limited to user data. The platform is aware of datasets that users many often need. So suggestions for combine/stitching can be from user data or data the platform deems relevant based on characteristics of a users' overall data map and/or in their user profile like industry. The platform may collect information about how a variety of users interact with data to determine suggestions for combining or stitching a given user's data.

The suggestions regarding tables to stitch together can use any variety of methodologies. One methodology can compare the set of column and/or row headings with sets of column and/or row headings that have been previously discovered in the system, either through examining the data from the same user, other users, or through a predefined library of data. When the system finds that a given document contains a similar set of column and/or row headings to one previously discovered, the platform can offer to extend the table with additional columns or rows from the other set.

Another stitching suggestion methodology can compare the columns and/or row headings to a set of known vocabularies, such as “all states in the US” or “all countries in the world” or “all stock ticker symbols in NASDAQ”. When the system discovers a substantial match between a given document's column and/or row headings and a known vocabulary, the platform can offer to extend the table with additional columns or rows from documents matching other elements of the vocabulary.

A further stitching suggesting methodology can maintain a set of statistical analyses of data sets, such as mean, median, standard deviation, size, frequency distribution, and compare a given set of data to previously analyzed sets. When the system discovers statistically similar sets of data, the platform can offer to extend the document with columns or rows from other similar documents.

Yet another stitching suggestion methodology can analyze the file for the presence of mathematical sequences, such as a continuously increasing set of dates or numbers, in a given row or column. The platform can offer to extend the remaining rows and/or columns with other data, where a corresponding row or column that continues the sequence.

Another stitching suggestion methodology can compute a collection of n-grams (strings of numbers, words, or other data of a given length), and compare the set of n-grams with the set of previously discovered n-grams. For example, if a document contains several trigrams such as:

11, 12, 19

UAE, UK, ES

23, 26.7, 28.9

2014 Q2, 2014 Q3, 2014 Q4

The platform can search for other documents with similar trigrams and attempt to extend the rows and/or columns with additional data that appear in those documents.

Another stitching suggestion methodology can calculate the Levenshtein distance between a given document and a set of previously discovered documents. If the Levenshtein distance is determined to be below a particular threshold relative to the files's size (or some other factor), the platform can attempt to stitch together the documents which have a low distance.

The components can be stored locally at a client system and/or they can be stored remotely (for example, at a cloud-based storage host). The user can then interact with the stored components and use/combine the components for use by an application. The components can be stored locally, on a networked hard-drive, in cloud-storage and the like.

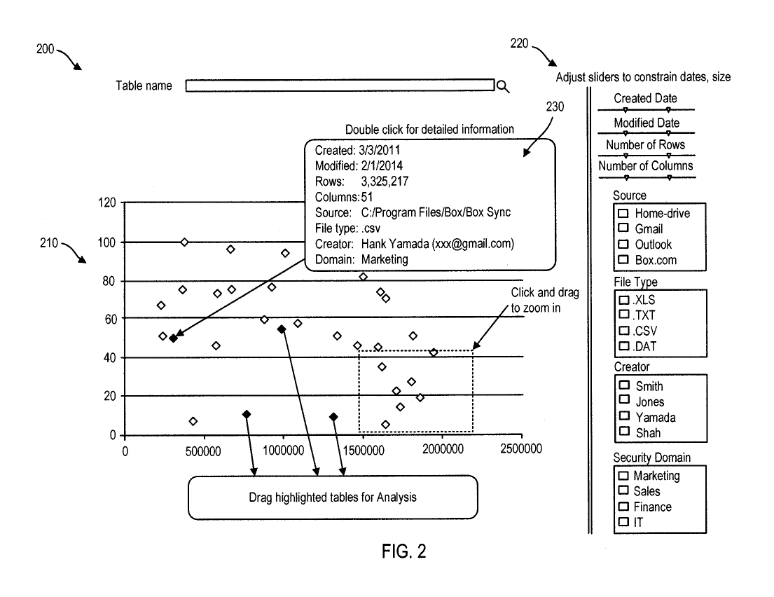

The attributes of the stored components can be utilized in differing manners. One example of a data map is illustrated in diagram 200 of FIG. 2. The data map of diagram 200 is a two dimensional scatter plot with the vertical and horizontal dimensions being based on different attributes of the corresponding identified files and/or tables. For example, the attributes can include, as described above, file attributes, location, number of rows/columns, file size, file creation/modification/access dates, as well as any other type of metadata or table/file statistics.

The data map of diagram 200 can be rendered in a graphical user interface (GUI) 210 that includes various GUI elements to allow a user to interact with the data map. The size, shape, color, and texture of the GUI elements can characterize other attributes of the corresponding identified file. In addition, in some cases, the data maps can be rendered in three or more dimensions (to reflect three or more attributes).

In some variations, the GUI 210 can allow to activate (e.g., click, hover over, etc.) a GUI element (e.g., a dot or other shape) so that complementary information 230 can be displayed (via a popup, bubble, text box, etc.) that characterizes the file/table. The complementary information to be viewed can be preset or user defined.

In some variations, the user, via a panel 220, can also filter the components (via sliders, checkboxes, input boxes, or simply visually on the chart by highlight a specific area). The panel 220 can, in some cases, be prepopulated with GUI elements that are based on attributes of the identified files. For example, a range for creation dates, a range for modified dates, a number of columns, a number of rows, the locations where the identified files reside, the identified file types, the creator of the identified files, the domain of the identified files, and the like. In some cases, a number corresponding to the number of identified files corresponding to each attribute can be displayed in the panel (as part of the GUI element or adjacent to it). In addition to filtering, an embedded search function (e.g., input box) can be used to select components that match specific criteria or search within the components for other characteristics.

Having narrowed down the components, the user can, by activating graphical user interface elements corresponding to the components/files, drag a GUI element that has been selected to another application (e.g., a spreadsheet software application) for analysis or use. For example, the GUI elements corresponding to dots on a scatter plot can be grabbed and dropped to an analytical screen for analysis (application icon, application launch pad, application palette, etc.). Other types of exporting techniques can be utilized including, for example, right clicking the GUI element (which causes a drop down menu to be rendered allowing the user to send the components/files to another application, etc.) and the like.

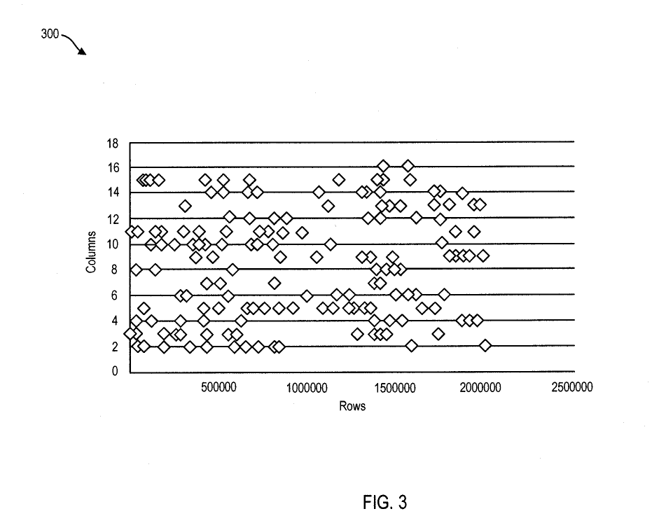

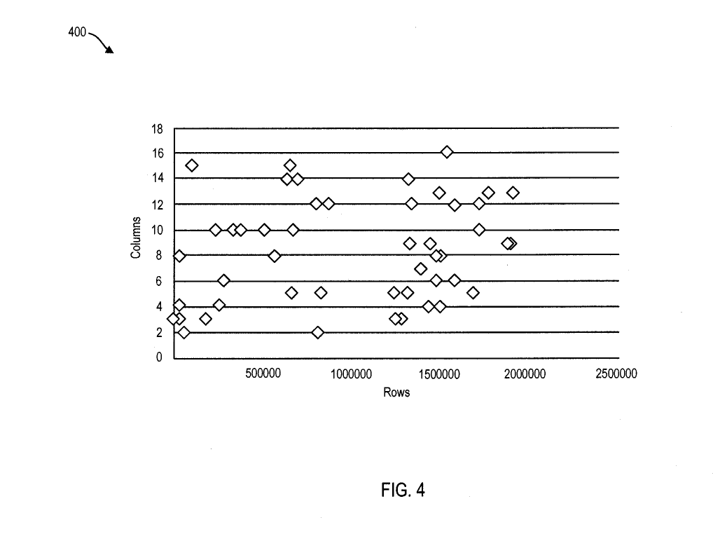

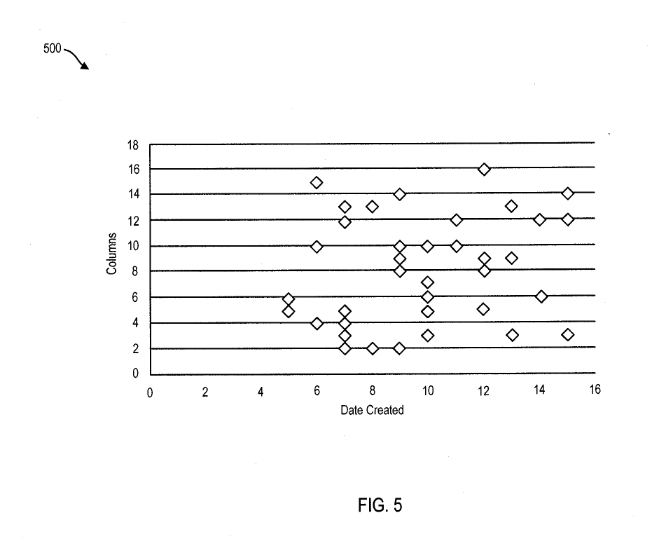

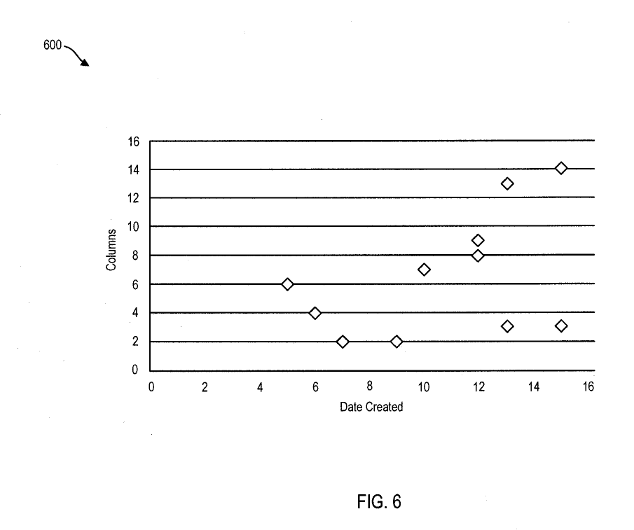

FIG. 3 is a diagram illustrating a data map 300 in which the files and/or tables are arranged corresponding to their respective number of columns and rows. FIG. 4 is a diagram including a data map 400 showing filtering of the files and/or tables illustrated in the data map 300 of FIG. 3; with such filtering being based, for example, on creation/modification/access date or the like (thereby resulting in fewer identified files and/or tables). FIG. 5 is a diagram 500 showing further filtering of the files and/or tables illustrated in the data map 400 of FIG. 4 (thereby resulting in fewer identified files and/or tables). FIG. 6 is a diagram 600 showing further filtering of the files and/or tables illustrated in the data map 500 of FIG. 5 (thereby resulting in fewer identified files and/or tables).

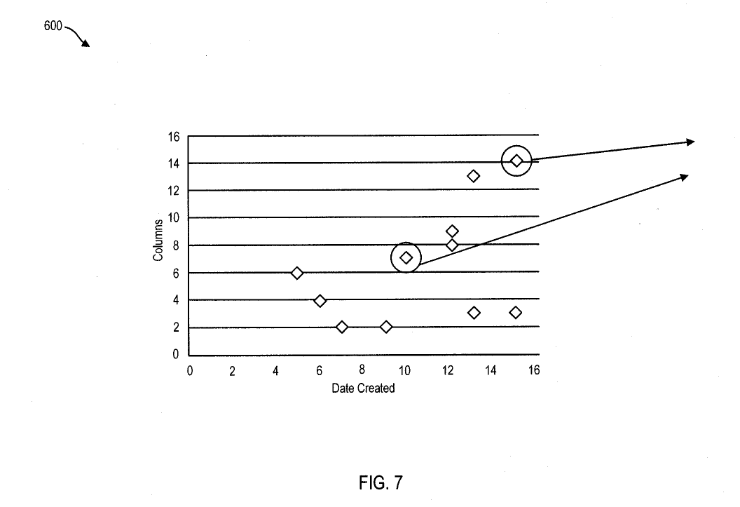

FIG. 7 is a diagram of a data map 700 illustrating importing of selected identified files and/or tables by dragging and dropping their corresponding GUI elements to an application. For example, the GUI element can be dragged and dropped onto an icon associated with the application, a launch pad associated with the application, and/or a palette or other workspace associated with the application.

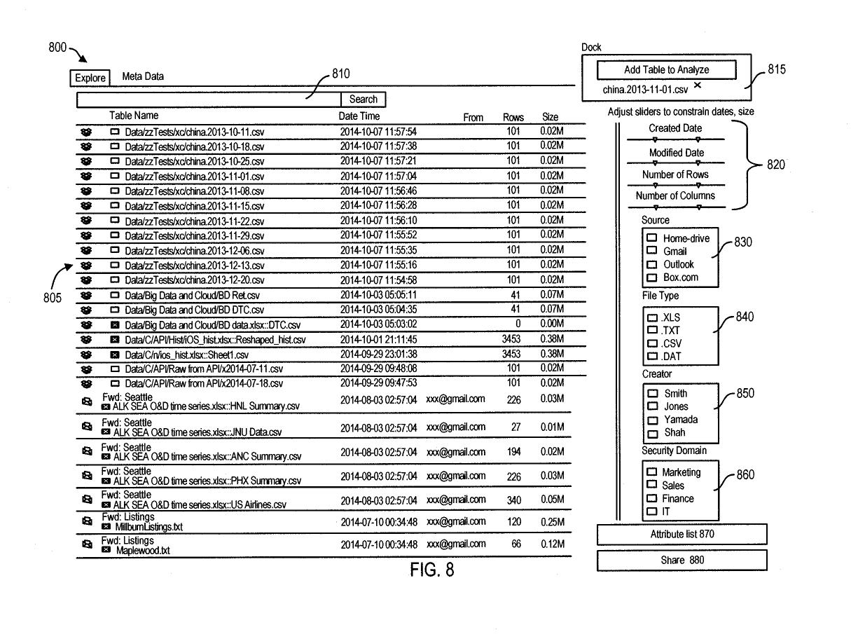

It will be appreciated that different types of visualizations can be utilized in order to efficiently characterize a large number of tables. For example, with regard to diagram 800 of FIG. 8, a tabular view 805 of the discovered files and attributes can provide additional interactivity for searching, selecting and combining data files. The tabular view 815 can show table details and selected attributes in sortable and searchable rows and columns. In such a visualization (as with regard to tabular data files), the number of rows or columns and date attributes in the discovered tables can be columns (which can be sorted). Attributes such as source, file or table name, and/or file path can be rows. This arrangement can provide a more granular view of the discovered components that certain users may prefer over the scatter plots.

The tabular view 805 can include, for example, a broad search box 810 (to effect filtering of the result set). Searching is often done to set the stage for stitching/combining by narrowing down the list files that meet certain keyword criteria, file names or other attributes. The resulting files can be added to the dock 815 for stitching/combining There are also options for other filtering elements 820 such as creation date, modified date, number of rows, number of columns, etc. Other types of filtering elements can be used such as file source 830, file type 840, file creator 850, security domain 860 and the like. In addition, an attribute list view 870 with a search box can be displayed to utilize the discovered files and attributes. Such attribute list 870 can be used to further filter the discovered files. In addition, a dock 815 can be provided that allows a user to select one or more of the files to further analyze (e.g., by selecting with a check box, dragging, dropping, or otherwise selecting etc.) or to stitch/combine. A share button 880 can also be used which can cause the selected files (i.e., the files in the dock 815, etc.) to be shared or otherwise saved.

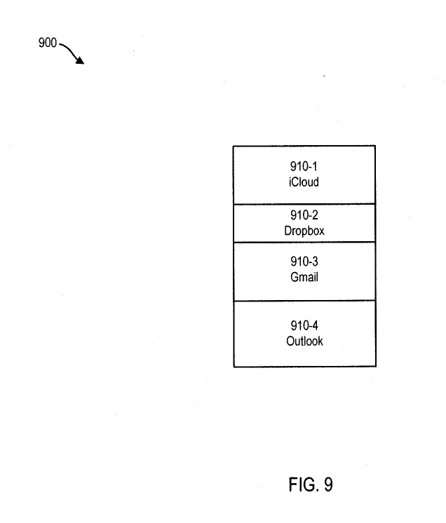

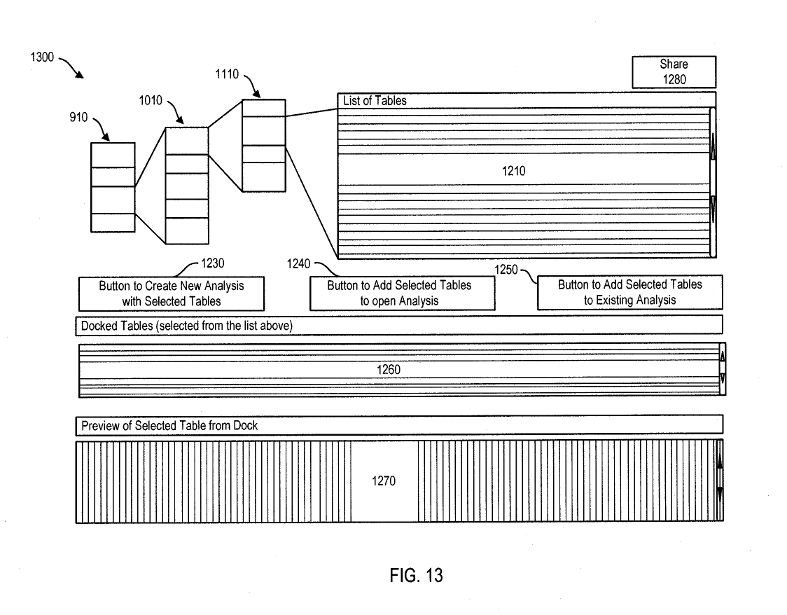

FIGS. 9-13 are views 900-1300 illustrating a different navigation interface for exploring tables stored within a distributed data storage system. Initially, with reference to view 900 of FIG. 9, graphical user interface elements 910-1, 910-2, 910-3, 910-4 can be presented that respectively correspond to an attribute in this case various data sources. The size of the graphical user interface elements 910-1, 910-2, 910-3, 910-4 can be variable and proportional to a number of files/tables available in the corresponding data source.

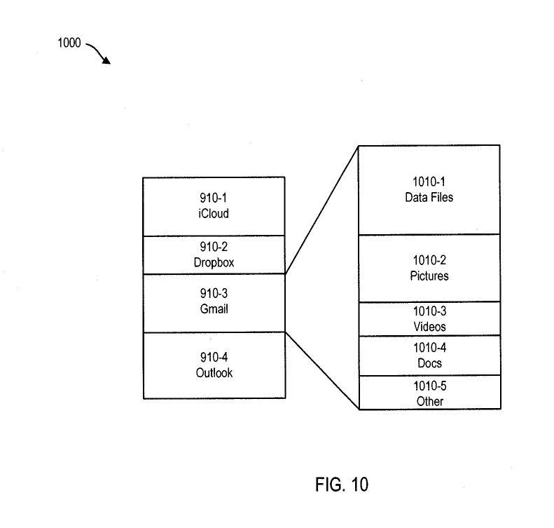

With reference now to view 1000 of FIG. 10, after a user has activated the graphical user interface element 1010-3 (which corresponds to GMAIL), graphical user interface elements 1010-1, 1010-2, 1010-3, 1010-4 can be presented that respectively correspond to various categories of files available at the corresponding data source (i.e., GMAIL). The size of the graphical user interface elements 1010-1, 1010-2, 1010-3, 1010-4, 1010-5 can be variable and proportional to a number of files/tables available in the corresponding category.

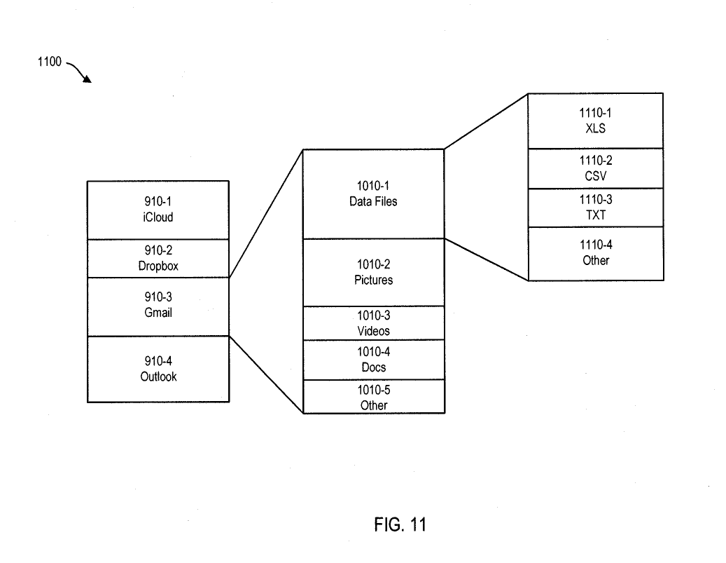

With reference now to view 1100 of FIG. 11, after a user has activated the graphical user interface element 1010-1 (which corresponds to data files), graphical user interface elements 1110-1, 1110-2, 1110-3, 1110-4 can be presented that respectively correspond to various file types/formats available within the selected category (i.e., data files). The size of the graphical user interface elements 1110-1, 1110-2, 1110-3, 1110-4 can be variable and proportional to a number of files/tables having such type/format.

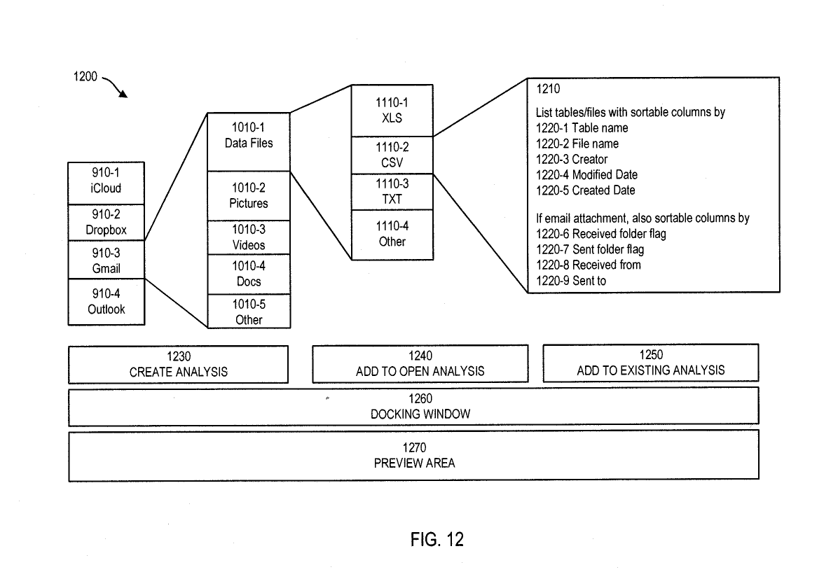

With reference now to view 1200 of FIG. 12, after a user has activated the graphical user interface element 1110-2 (which corresponds to csv format files), a window 1210 can be presented that includes graphical user interface elements 1220-1, 1220-2, 1220-3, 1220-4, 1220-5, 1220-6 that form part of a sortable table list that includes attributes of the tables. The window 1210 can be a list with sortable columns identifying attributes such as table name, file name, creator name, date when last modified, date when created, whether the data file was an e-mail attachment, received folder flags, sent folder flag, received from, sent to, data received, date sent, and the like. In some variations, the window 1210 can be displayed concurrently with one or graphical user interface elements 1230, 1240, 1250 that, in turn, can be used to initiate one or more actions associated with a table that is selected in the window 1210 (via the corresponding graphical user interface element 1220-1, 1220-2, 1220-3, 1220-4, 1220-5, 1220-6). For example, a user can drag and drop a table from the window 1210 to a docking area 1260.

The docking area 1260 can include tables of files (with corresponding graphical user interface elements) that have been docked with the same columns and features as the sortable list shown in the window 1210. A new analysis workflow can be initiated using one or more of the files in the docking area 1260 via a create analysis button 1230. In addition, one or more of the files in the docking area 1260 can be added to an open analysis 1240 by activating an add to existing analysis button 1240 or to an existing but not open analysis 1250. Or these file(s) can be shared using button 1280. Lastly, a preview window 1270 can provide a preview of one of the tables that is selected in the docking area 1260. Or in the case of stitching/combining it can show the resulting larger file(s).

Regardless of the view, all search/filer criteria used to find and/or combine tables(s) are recorded. They can be saved and used again. Criteria can also be designated as “active” by the user and left running such that new files discovered in the crawling can be added to a predesigned search/filer process as they are discovered. An objective of searching across sources and file types is often for updating existing work. “Active” searches/filter streamline the process of updating. A dashboard screen is included that allows users to view the update availability of saved searches/filters, manage the frequency of triggering these, and when triggered providing several standard charts or tables on how having triggered these has changed the rows columns and other attributes of the previously search/filtered run.

In the event of sharing, the application can also be instructed to share updated searches/filers as new data gets discovered.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method for implementation by one or more data processors forming part of at least one computing system, the method comprising:
accessing or crawling, by at least one data processor, data source locations available to a user to identify files comprising data;
analyzing, by at least one data processor, each identified file to obtain attributes characterizing the file; and
generating, by at least one data processor in a graphical user interface, a data map characterizing the identified files along at least two dimensions, a first dimension being based on a first attribute of the corresponding identified file, a second dimension being based on a second attribute of the corresponding identified file, at least one identified file having a corresponding graphical user interface element.

2. A method as in claim 1, wherein the data map comprises a scatter plot.

3. A method as in claim 1, wherein the data map comprises a tabular form.

4. A method as in claim 1 further comprising:
receiving, by at least one data processor, user-generated input activating at least one of the graphical user interface elements with at least one associated identified file; and
initiating, by at least one data processor, at least one action using the at least one associated identified file.

5. A method as in claim 1 further comprising:
receiving, by at least one data processor, user-generated input activating at least one of the graphical user interface elements with at least one associated identified file; and
displaying further data characterizing the at least one associated identified file.

6. A method as in claim 1 further comprising:
receiving, by at least one data processor, user-generated input activating at least one of the graphical user interface elements with at least one associated identified file; and
initiating, by at least one data processor, importation of the at least one associated identified file into an application.

7. A method as in claim 1 further comprising:
receiving, by at least one data processor, user-generated input activating at least one of the graphical user interface elements with at least one associated identified file; and
initiating, by at least one data processor, sharing of the at least one associated identified file.

8. A method as in claim 6, wherein the sharing comprises: generating a unique hashtag or uniform resource locator (URL), which when activated, causes the corresponding at least one identified file to be accessed.

9. A method as in claim 7, wherein the sharing comprises: specifying access restrictions on the corresponding at least one identified file.

10. A method as in claim 7, wherein the sharing encapsulates any search or filtering criteria used in connection with discovery of at least one corresponding identified file.

11. A method as in claim 10, wherein the search is an active search that refreshes once new files are accessed or crawled.

12. A method as in claim 1, wherein a size and/or color of each graphical user interface element is based on a further attribute of the corresponding identified file that is different from the first attribute and the second attribute.

13. A method as in claim 1, wherein a shape of each graphical user interface element is based on a further attribute of the corresponding identified file that is different from the first attribute and the second attribute.

14. A method as in claim 1, wherein the data map characterizes the identified files along at least one other dimension with each dimension being based on a different attribute of the corresponding identified file.

15. A method as in claim 1, wherein the data within each identified file comprises tabular data.

16. A method as in claim 1, wherein the data source locations are selected from a group consisting of: local data stores, network accessible data stores, e-mail servers, cloud-based data storage services.

17. A method as in claim 1, wherein the attributes are selected from a group consisting of: identified file location, column names, row names, a number of rows, a number of columns, file size, file creation date, application that generated the identified file, file modification date, file access dates, number of times the file has been accessed, file type, author of the file, individuals who have accessed the file, access control list data, authorization level of entities who can or who have accessed the file, department of entities who can or who have accessed the file, exclusion lists, data ranges, data formats, table structure, file structure, mathematical sequences within the file, keywords contained within the file, and summaries of some or all of the contents of the file.

18. A method as in claim 1, wherein the data comprises data to render at least one pivot table.

19. A method as in claim 1 further comprising:
parsing at least one identified file into two or more components;
wherein the attributes are obtained for each component and each component has a different corresponding graphical user interface element within the data map.

20. A method as in claim 19, wherein each component comprises a separate set of tabular data.

21. A method as in claim 1, wherein the identified files have types selected from a group consisting of: .acv, .adp, .ai, .aif, .aiff, .air, .amp, .aod, .aps, .asc, .asf, .aspx, .att, .atf, .atx, .au, .avi, .aux, .bak, .bas, .bck, .bin, .bd, .bkf, .bmc, .bmp, .bud, .cbl, .cc, .cd, .cct, .cda, .cdd, .cdr, .cdt, .cdx, .cfm, .cfml, .clp, .cpp, .cs, .csproj, .cst, .csv .ctl, .ctx, .cur, .cwf, .cxx, .dat, .db, .dbc, .dbf, .dbquery, .dbx, .dir, .doc, .docx, .dot, .dotm, .dotx, .drw, .dwf, .dwfx, .dwg, .dwt, .dxb, .dxf, .dxr, .eml, .eps, .eps2, .exe, .fla, .flk, .fly, .fm, .fp5, .fp7, .frm, .gvp, .gz, .gzip, .hlp, .ht, .htc, .htm, .html, hta, .iif, .img, .ind, .isd, .ism, .iso, .iss, .iwp, .jad, .jar, .java, .jfif, .jgw, .jhtm, .jhtml, .jnl, .job, .jpg, .jpeg, .js, .lab, .ldf, .ldif, lgo, .lha, .lit, ink, .lock, .log1, .log2, .lzh, .mlv, .m2ts, .m3u, .m4a, .m4r, .map, .maq, .mar, .marc, .mat, .mco, .md5, .mdb, .mde, .mdf, .mdi, .mdmp, .mht, .mid, .mif, .mim, .mix, .mmap, .mod, .modd, .moff, .mot, .mov, .movie, .moz, .mp2, .mp3, .mp4, .mpe, .mpeg, .mpg, .mpt, .msg, .msdvd, .msg, .msi, .msm, .msp, .mst, .msv, .myd, .myi, .nch, .ncb, .nk2, nn, .nrg, .nws, .o, .obj, .oca, .ocx, .odc, .oft, .ops, .opt, .pab, .pal, .par, .par2, .part, .pbm, .pce, pdd, .pde, .pdf, .pic, .pict, .pid, .pif, .pip, .pjp, .jpjeg, .pmd, .png, .pot, .ppm, .ppt, .prf, .prn, .ps, .psd, .psp, .pst, .pub, .qif, .qt, .r00, .r01, .r02, .r03, .r04, .r05, .ra, .ram, .rar, .raw, .rc, .rdi, .reg, .rm, .rpc, .rtf, .rtx, .sas, .sas7dbat, .sas7bvew, .sav, .sbl, .sbx, .scf, .scr, .sea, .sfx, .sh, .smi, .snd, .snp, .spo, .sps, .sql, .sqlite, .sqm, .stc, .std, .sti, .stm, .sv7, .sxc, .sxg, .sxm, .sxp, .sxw, .syd, .syo, .sys, .tab. .tar, .tif, .tiff, .tib, .tmb, .tmd, .tsv, .txt, .vb, .vbproj, .vbs, .vbx, .vcf, .vhd, .vm, .vsd, .vsi, .vsix, .vspscc, .vsscc, .vssscc, .wab, .wav, .wave, .wdb, .wer, .whb, .win, .wk1, .wk2, .wk3, .wk4, .wks, .wma, .wmv, .wms, .wmz, .wor, .wp, .wp2, .wp3, .wp4, .wpd, .wpp, .wps, .wpt, .prf, .wrj, .wrl, .wrz, .wtv. .wvf, .wvx, .xhtml, .xla, .xlam, .xlb, .xlc, .xld, .xlk, .xll, .xlm, .xlr, .xls, .xlsb, .xlsm, .xlsx, .xlt, .xltm, .xlv, .xlw, .xml, .xps, .xrp, .xsd, .xslt, .xspf, .xtf, .xxx, zip, .zipx, and .zix format files.

22. A method as in claim 1 further comprising:
stitching together at least two identified files to form a single file.

23. A method as in claim 22, wherein the stitching comprises:
identifying common attributes among the identified files; and
combining the files using at least one of the common attributes.

24. A method as in claim 23, wherein the identifying common attributes comprises:
receiving user-generated input specifying the common attributes.

25. A method as in claim 23, wherein the common attributes are selected from a group consisting of: identified file location, column names, row names, a number of rows, a number of columns, file size, file creation date, application that generated the identified file, file modification date, file access dates, number of times the file has been accessed, file type, author of the file, individuals who have accessed the file, access control list data, authorization level of entities who can or who have accessed the file, department of entities who can or who have accessed the file, exclusion lists, data ranges, data formats, table structure, file structure, mathematical sequences within the file, keywords contained within the file, and summaries of some or all of the contents of the file.

26. A method as in claim 23, wherein the common attributes are identified using at least one stitching suggestion methodology.

27. A method as in claim 23 further comprising:
displaying, in the graphical user interface, a keyword cloud identifying common attributes among the identified files, wherein the user-generated input comprises selecting at least one graphical user interface element associated with the specified common attributes.

28. A method as in claim 23, wherein the identifying common attributes comprises:
polling or accessing an attributes index to identify the files having the common attributes.

29. A method as in claim 1, wherein at least one accessed or crawled data source locations comprise at least one compressed file, and the method further comprises:
decompressing the at least one compressed file.

30. A method as in claim 1, wherein at least one accessed or crawled data source locations comprise at least one encrypted file, and the method further comprises:
decrypting the at least one decrypted file.

31. A method as in claim 1 further comprising:
receiving, by at least one data processor, user-generated input activating at least one of the graphical user interface elements with at least one corresponding identified file; and
opening an new analysis of files from the data source locations using the at least one corresponding identified file.

32. A method as in claim 1 further comprising:
receiving, by at least one data processor, user-generated input activating at least one of the graphical user interface elements with at least one corresponding identified file; and
adding the at least one corresponding identified file to an existing analysis of files from the data source locations.

33. A non-transitory computer program product storing instructions which, when executed by at least one data processor forming part of at least one computing system, result in operations comprising:
accessing or crawling data source locations available to a user to identify files comprising data;
analyzing each identified file to obtain attributes characterizing the file; and
generating a data map characterizing the identified files along at least two dimensions, a first dimension being based on a first attribute of the corresponding identified file, a second dimension being based on a second attribute of the corresponding identified file, at least one identified file having a corresponding graphical user interface element.

34. A system comprising:
at least one data processor; and
memory storing instructions which, when executed by the at least one data processor, result in operations comprising:
accessing or crawling data source locations available to a user to identify files comprising data;
analyzing each identified file to obtain attributes characterizing the file; and
generating a data map characterizing the identified files along at least two dimensions, a first dimension being based on a first attribute of the corresponding identified file, a second dimension being based on a second attribute of the corresponding identified file, at least one identified file having a corresponding graphical user interface element.

35. A method for implementation by one or more data processors forming part of at least one computing system, the method comprising:
displaying, in a graphical user interface, available categories of files at a first level;
receiving, in the graphical user interface, user-generated input selecting one of the categories at the first level;
displaying, in the graphical user interface, available categories of files at a second level;
receiving, in the graphical user interface, user-generated input selecting one of the categories at the second level; and
displaying, in the graphical user interface, available categories of files at the third level;
wherein each category is rendered in the graphical user interface having a size relative to a number of corresponding files.

36. A method as in claim 35, wherein the first level comprises data source types, the second level comprises data file content types, and the third level comprises data file format types.

37. A method for implementation by one or more data processors forming part of at least one computing system, the method comprising:
accessing, by at least one data processor, an index specifying attributes for each of a plurality of files stored at a plurality of data source locations;
generating, by at least one data processor in a graphical user interface, a data map characterizing the files along at least two dimensions, a first dimension being based on a first attribute of the corresponding file, a second dimension being based on a second attribute of the corresponding file, at least one file having a corresponding graphical user interface element;
receiving, by at least one data processor, user-generated input activating at least one of the graphical user interface elements with at least one associated file; and
initiating, by at least one data processor, an action using the at least one associated file.
